(19) United States
(12) Patent Application Publication
(10) Pub. No.: US 2013/0207980 A1
(43) Pub. Date: Aug. 15, 2013

(54) VISUALIZATION OF DATA CLUSTERS

(71) Applicants: ANIL BABU ANKISETTIPALLI, Bangalore (IN); Ashok Kumar Kn, Bangalore (IN)

(72) Inventors: ANIL BABU ANKISETTIPALLI, Bangalore (IN); Ashok Kumar Kn, Bangalore (IN)

(21) Appl. No.: 13/371,579

(22) Filed: Feb. 13, 2012

(51) Int. Cl. G06T 11/20

(52) U.S. Cl. 345/440

(57) ABSTRACT

In one embodiment, a plurality of data records is received. Further, the received plurality of data records are classified into one or more data clusters based on parameters associated with the plurality of data records. Furthermore, a visualization panel on a computer generated graphical user interface is presented for graphically indicating number of data records in a data cluster of the one or more data clusters, density of the data records in the data cluster and proximity between the one or more data clusters. Also, the visualization panel graphically displays parameters associated with the one or more data clusters and distribution of data in the data cluster of the one or more data cluster.

### FIELD

Embodiments generally relate to presentation of data clusters on a computer generated user interface and more particularly to methods and systems to graphically present detailed information of the data clusters.

### BACKGROUND

Classification of data records or objects into different groups, known as data clustering, is helpful in exploratory statistical data analysis. Examples of exploratory statistical data analysis include pattern-analysis, decision making, document retrieval and image segmentation. Once clustering is identified on the data records, it is more easily understood with the help of graphical visualization. On the other hand, analyzing the data clusters manually is challenging since the human brain has difficulty in visualizing data clusters. Several methods of displaying a visualization of data clusters such as a three-dimensional map using spatial relationships among the data clusters are known in the art. However, analyzing the data clusters and differentiating the data clusters visually may be complex since detailed information on the clusters and how the records are grouped in the clusters are lacking.

### SUMMARY

Various embodiments of systems and methods to visualize data clusters on a visualization panel are described herein. In one aspect, a plurality of data records is received. Further, the received plurality of data records are classified into one or more data clusters based on parameters associated with the plurality of data records. Furthermore, a visualization panel on a computer generated graphical user interface is presented for graphically indicating number of data records in a data cluster of the one or more data clusters, density of the data records in the data cluster and proximity between the one or more data clusters. Also, the visualization panel graphically displays parameters associated with the one or more data clusters and distribution of data in the data cluster of the one or more data cluster.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity.

The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method of visualizing data clusters on a visualization panel, according to an embodiment.

FIG. 2 is a user interface showing a visualization panel displaying data clusters, according to an embodiment.

FIGS. 3A and 3B illustrate a first portion of a visualization panel, according to an embodiment.

FIG. 4 illustrates a second portion of a visualization panel, according to an embodiment.

FIGS. 5A to 5F illustrate a third portion of a visualization panel, according to an embodiment.

FIGS. 6A to 6C illustrate a fourth portion of a visualization panel, according to an embodiment.

FIG. 7 is a block diagram of an exemplary computer system, according to an embodiment.

### DETAILED DESCRIPTION

Embodiments of techniques to visualize data clusters are described herein. Grouping a set of data records or objects into one or more groups or data clusters is known as data clustering. The data cluster is made up of number of data records with similar parameters or traits when compared to other data clusters. The data records may be statistical or numeric data. In one exemplary embodiment, the data records are grouped in data clusters using a data mining algorithm. The data mining algorithm analyzes the set of data records using a set of rules that describe how the data records are grouped together. Further, the data clusters are presented on a computer generated user interface for analyzing the data clusters. The computer may be desktop computers, work stations, laptop computers, hand held computers, smart phones, console devices or the like.

According to one embodiment, the computer generated user interface includes a visualization panel to display detailed information of the data clusters. The visualization panel may include a canvas divided into one or more portions depicting how the data records are grouped into data clusters. The single visualization panel displays a number of data records in the data clusters, density of the data clusters, proximity between the data clusters and parameters of the data clusters in the one or more portions. Since detailed information of how the data clusters are formed is displayed on the single visualization panel, analyzing the data clusters by evaluating the parameters of the data clusters may be easier.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

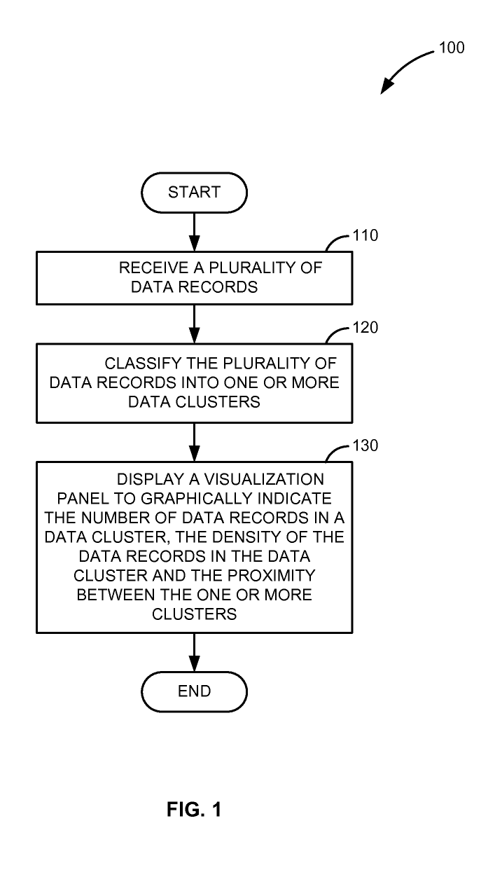

FIG. 1 is a flow diagram 100 illustrating a method of visualizing data clusters on a visualization panel, according to an embodiment. At step 110, a plurality of data records are received. The data records may include numeric values. For example, to analyze nutrition level of mammal's milk, data records containing details of nutrition in milk of different mammals are collected as depicted in Table 1.

TABLE 1

| Mammal | Water % | Protein % | Fat % | Lactose % | Ash % |
|---|---|---|---|---|---|
| Horse | 90.1 | 2.6 | 1 | 6.9 | 0.35 |
| Orangutan | 88.5 | 1.4 | 3.5 | 6 | 0.24 |
| Monkey | 88.4 | 2.2 | 2.7 | 6.4 | 0.18 |
| Donkey | 90.3 | 1.7 | 1.4 | 6.2 | 0.4 |
| Hippo | 90.4 | 0.6 | 4.5 | 4.4 | 0.1 |
| Camel | 87.7 | 3.5 | 3.4 | 4.8 | 0.71 |
| Bison | 86.9 | 4.8 | 1.7 | 5.7 | 0.9 |
| Buffalo | 82.1 | 5.9 | 7.9 | 4.7 | 0.78 |
| Guinea Pig | 81.9 | 7.4 | 7.2 | 2.7 | 0.85 |
| Cat | 81.6 | 10.1 | 6.3 | 4.4 | 0.75 |
| Fox | 81.6 | 6.6 | 5.9 | 4.9 | 0.93 |
| Llama | 86.5 | 3.9 | 3.2 | 5.6 | 0.8 |
| Mule | 90 | 2 | 1.8 | 5.5 | 0.47 |
| Pig | 82.8 | 7.1 | 5.1 | 3.7 | 1.1 |
| Zebra | 86.2 | 3 | 4.8 | 5.3 | 0.7 |
| Sheep | 82 | 5.6 | 6.4 | 4.7 | 0.91 |
| Dog | 76.3 | 9.3 | 9.5 | 3 | 1.2 |
| Elephant | 70.7 | 3.6 | 17.6 | 5.6 | 0.63 |
| Rabbit | 71.3 | 12.3 | 13.1 | 1.9 | 2.3 |
| Rat | 72.5 | 9.2 | 12.6 | 3.3 | 1.4 |
| Deer | 65.9 | 10.4 | 19.7 | 2.6 | 1.4 |
| Reindeer | 64.8 | 10.7 | 20.3 | 2.5 | 1.4 |
| Whale | 64.8 | 11.1 | 21.2 | 1.6 | 1.7 |
| Seal | 46.4 | 9.7 | 42 | 0 | 0.85 |
| Dolphin | 44.9 | 10.6 | 34.9 | 0.9 | 0.53 |

Table 1 includes data of percentage of water, protein, fat, lactose and ash in milk of different mammals, collectively called as data records of plurality of mammals' milk.

At step 120, the plurality of data records are classified into one or more data clusters based on parameters associated with the plurality of data records. For example, the parameters may be percentage of water, protein, fat, lactose and ash. In one exemplary embodiment, the classification is performed by executing a data mining algorithm such as but not limited to a ‘K-Means’ algorithm and ‘CURE’ (Clustering Using REpresentatives) algorithm. The ‘K-Means’ algorithm is a method of data cluster analysis which aims to partition ‘n’ data records into ‘k’ data clusters logically (e.g., an option is provided for a user to input a value for ‘k’) in which each data record belongs to the data cluster with the nearest mean. The CURE algorithm is a method of data cluster analysis for large databases that is robust to outliers and identifies data clusters having non-spherical shapes and wide variances in size.

For example, when the ‘K-Means’ algorithm is executed for the data records depicted in Table 1 with ‘k’ as 3, the data records are classified into three data clusters as depicted in Table 2.

TABLE 2

| | | | | | | Data |
|---|---|---|---|---|---|---|
| Mammal | Water % | Protein % | Fat % | Lactose % | Ash % | Cluster |
| Horse | 90.1 | 2.6 | 1 | 6.9 | 0.35 | 1 |
| Orangutan | 88.5 | 1.4 | 3.5 | 6 | 0.24 | 1 |
| Monkey | 88.4 | 2.2 | 2.7 | 6.4 | 0.18 | 1 |
| Donkey | 90.3 | 1.7 | 1.4 | 6.2 | 0.4 | 1 |
| Hippo | 90.4 | 0.6 | 4.5 | 4.4 | 0.1 | 1 |
| Camel | 87.7 | 3.5 | 3.4 | 4.8 | 0.71 | 1 |
| Bison | 86.9 | 4.8 | 1.7 | 5.7 | 0.9 | 1 |
| Buffalo | 82.1 | 5.9 | 7.9 | 4.7 | 0.78 | 3 |
| Guinea Pig | 81.9 | 7.4 | 7.2 | 2.7 | 0.85 | 3 |
| Cat | 81.6 | 10.1 | 6.3 | 4.4 | 0.75 | 3 |
| Fox | 81.6 | 6.6 | 5.9 | 4.9 | 0.93 | 3 |
| Llama | 86.5 | 3.9 | 3.2 | 5.6 | 0.8 | 1 |
| Mule | 90 | 2 | 1.8 | 5.5 | 0.47 | 1 |
| Pig | 82.8 | 7.1 | 5.1 | 3.7 | 1.1 | 3 |
| Zebra | 86.2 | 3 | 4.8 | 5.3 | 0.7 | 1 |
| Sheep | 82 | 5.6 | 6.4 | 4.7 | 0.91 | 3 |
| Dog | 76.3 | 9.3 | 9.5 | 3 | 1.2 | 3 |
| Elephant | 70.7 | 3.6 | 17.6 | 5.6 | 0.63 | 3 |
| Rabbit | 71.3 | 12.3 | 13.1 | 1.9 | 2.3 | 3 |
| Rat | 72.5 | 9.2 | 12.6 | 3.3 | 1.4 | 3 |
| Deer | 65.9 | 10.4 | 19.7 | 2.6 | 1.4 | 2 |
| Reindeer | 64.8 | 10.7 | 20.3 | 2.5 | 1.4 | 2 |
| Whale | 64.8 | 11.1 | 21.2 | 1.6 | 1.7 | 2 |
| Seal | 46.4 | 9.7 | 42 | 0 | 0.85 | 2 |
| Dolphin | 44.9 | 10.6 | 34.9 | 0.9 | 0.53 | 2 |

The output of the ‘K-Means’ algorithm as depicted in Table 2 includes grouping of ‘horse’, ‘orangutan’, ‘monkey’, ‘donkey’, ‘hippo’, ‘camel’, ‘bison’, ‘llama’, ‘mule’ and ‘zebra’ into data cluster 1, grouping of ‘deer’, ‘reindeer’, ‘whale’, ‘seal’ and ‘dolphin’ into data cluster 2, and grouping ‘buffalo’, ‘guinea pig’, ‘cat’, ‘fox’, ‘pig’, ‘sheep’, ‘dog’, ‘elephant’, ‘rabbit’ and ‘rat’ are grouped into data cluster 3. In one embodiment, the data clusters are grouped based on the center value of the parameters (e.g., percentage of water, percentage of protein, percentage of fat, percentage of lactose and percentage of ash) as depicted in Table 3.

TABLE 3

| Data Cluster | Sum of | No. of data | Centers | | | | |
|---|---|---|---|---|---|---|---|
| Number | Squares | records | Water % | Protein % | Fat % | Lactose % | Ash % |
| Data | 59.41 | 10 | 88.50 | 2.57 | 2.80 | 5.68 | 0.485 |
| Cluster 1 | | | | | | | |
| Data | 883.10 | 5 | 57.36 | 10.50 | 27.62 | 1.52 | 1.176 |
| Cluster 2 | | | | | | | |
| Data | 446.50 | 10 | 78.28 | 7.71 | 9.16 | 3.89 | 1.085 |
| Cluster 3 | | | | | | | |

The ‘K-Means’ algorithm classify the data records of Table 1 into three data clusters based on the center values of percentage of water, percentage of protein, percentage of fat, percentage of lactose and percentage of ash. The center values may be the aggregation of the parameters associated with the data records in the data cluster. The aggregation may be an average (e.g., mean, mode, median), a total, or other function (e.g., max). Thereby, the data records having parameters closer to 88.5% of water, 2.57% of protein, 2.8% of fat, 5.68% of lactose and 0.485% of ash are grouped as data cluster 1. The data records having parameters closer to 57.36% of water, 10.5% of protein, 27.62% of fat, 1.52% of lactose and 1.176% of ash are grouped as data cluster 2. Further, the data records having parameters closer to 78.28% of water, 7.71% of protein, 9.16% of fat, 3.89% of lactose and 1.085% of ash are grouped as data cluster 3. In one embodiment, sum of squares can be used to determine closeness parameters to the center values.

Sum of square is calculated by the ‘K-Means’ algorithm. The sum of squares is used to estimate closeness of data records within each data cluster. In other words, sum of squares is used to estimate density of the data cluster. Density of a data cluster can be defined as sum of squares of distances from a center value of the data cluster to each data record in the data cluster. For example, data cluster 1 includes 10 data records. In other words, these 10 data records include parameters closer to the center values as depicted in Table 3. With the sum of squares, the proximity of the 10 data records is identified. Greater the value of sum of squares, higher is the density of data records in the data cluster and vice versa.

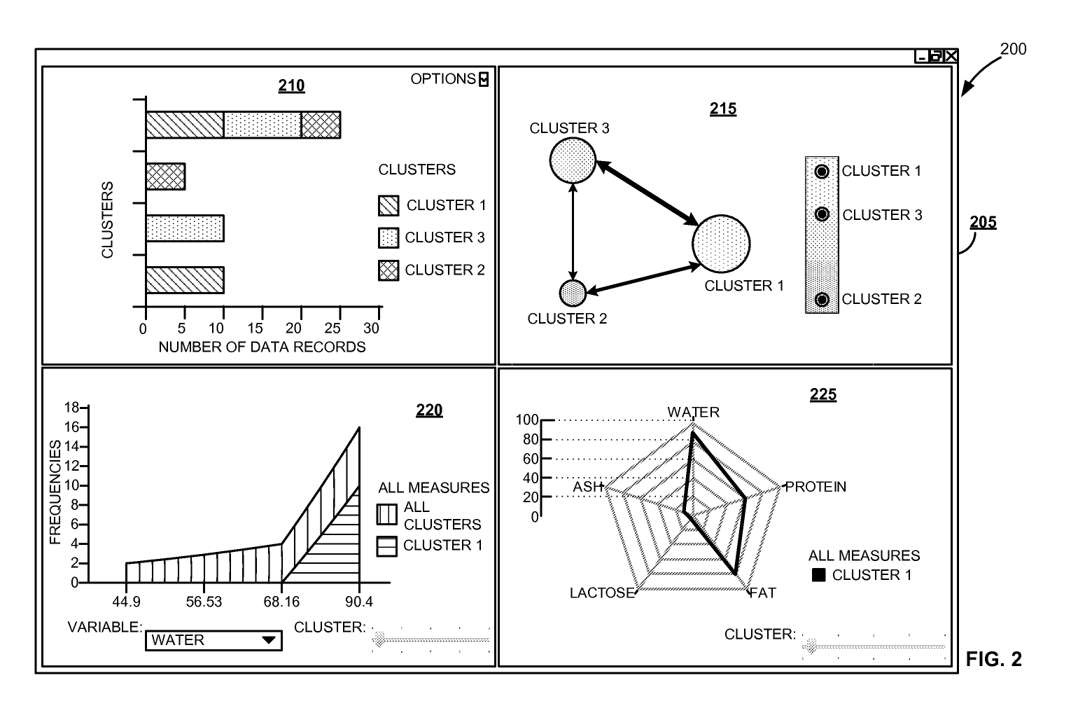

At step 130, a visualization panel is presented on a computer generated graphical user interface for graphically displaying the output of ‘K-Means’ algorithm. In other words, number of data records in the data cluster, density of data records in the data cluster and proximity between the data clusters are graphically presented on the visualization panel. Further, the visualization panel graphically display parameters associated with the data clusters and distribution of data in the data cluster. Thus, the output of the ‘K-Means’ algorithm as depicted in Table 3 is represented graphically in a way indicating how the data records are grouped into data clusters. The visualization panel is explained in greater detail in FIGS. 2 to 6.

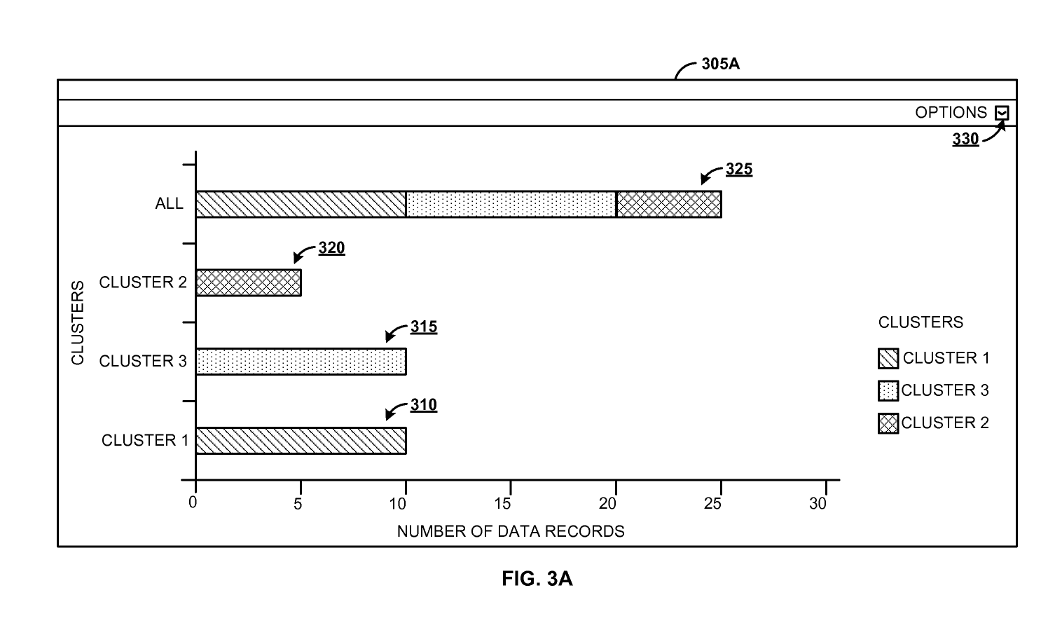

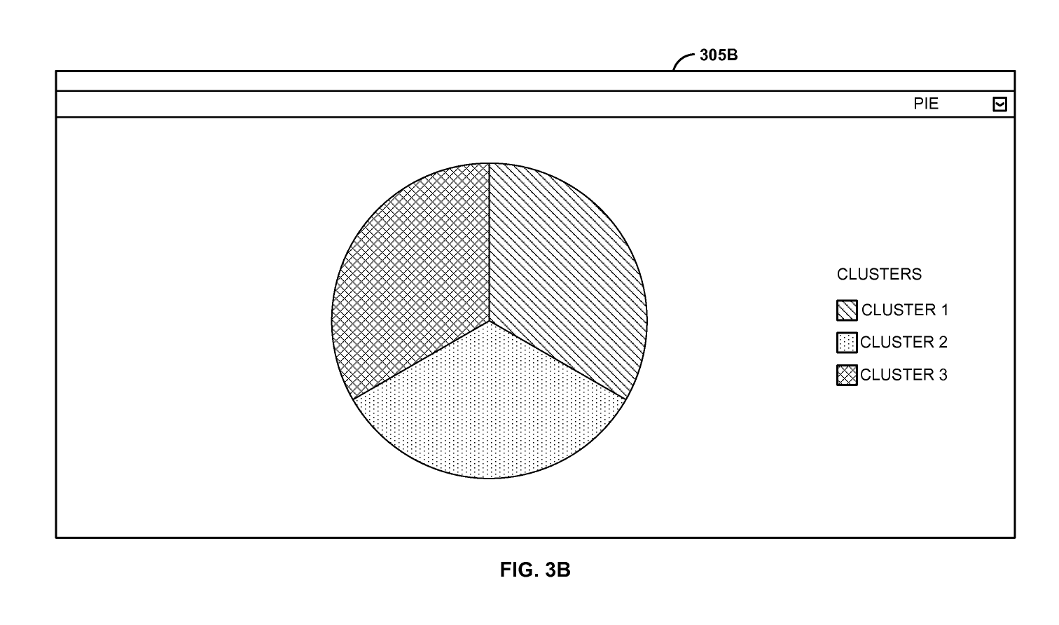

FIG. 2 is a user interface 200 showing a visualization panel 205 displaying data clusters, according to an embodiment. In one exemplary embodiment, the visualization panel 205 may include a canvas, which is divided into four portions (e.g., 210, 215, 220 and 225). A first portion 210 graphically displays number of data records in a data cluster of the one or more data clusters. For example, as per Table 2, data cluster 1 includes 10 data records, data cluster 2 includes 5 data records and data cluster 3 includes 10 data records. The same is graphically represented in the first portion 210 of the visualization panel 205. The first portion 210 is described in greater detail in FIGS. 3A and 3B.

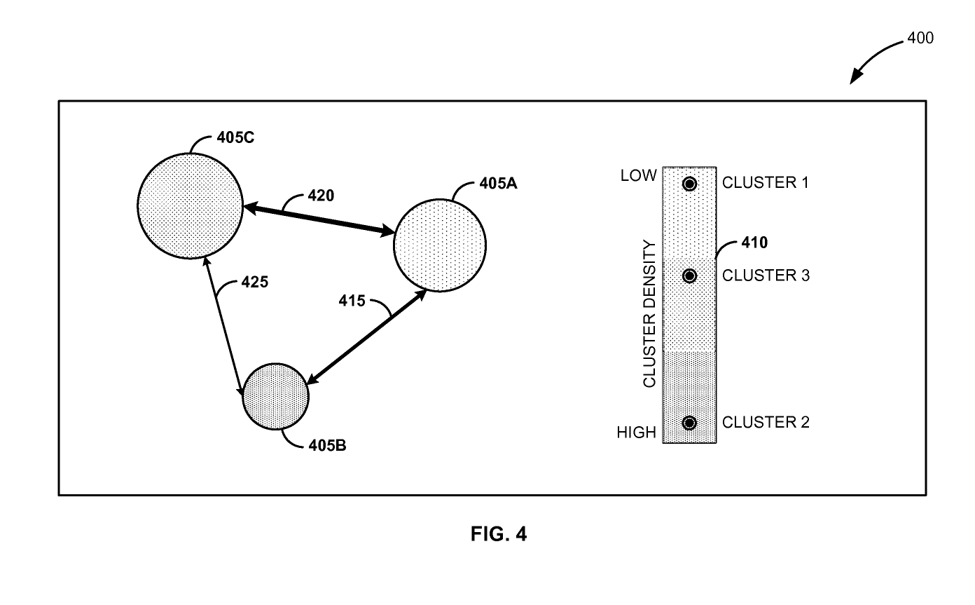

In one embodiment, a second portion 215 graphically displays density of the data clusters and proximity between the data clusters. In one exemplary embodiment, the data clusters are represented as nodes. Further, size of the nodes depends on the number of data records in the data cluster. Connecting lines between the nodes are used to present the proximity between the data clusters. For example, greater the thickness of the node connecting lines, higher is the proximity. Furthermore, the density of the data clusters is presented using shades. For example, denser the shade, higher the density. The second portion 215 is described with an example in FIG. 4.

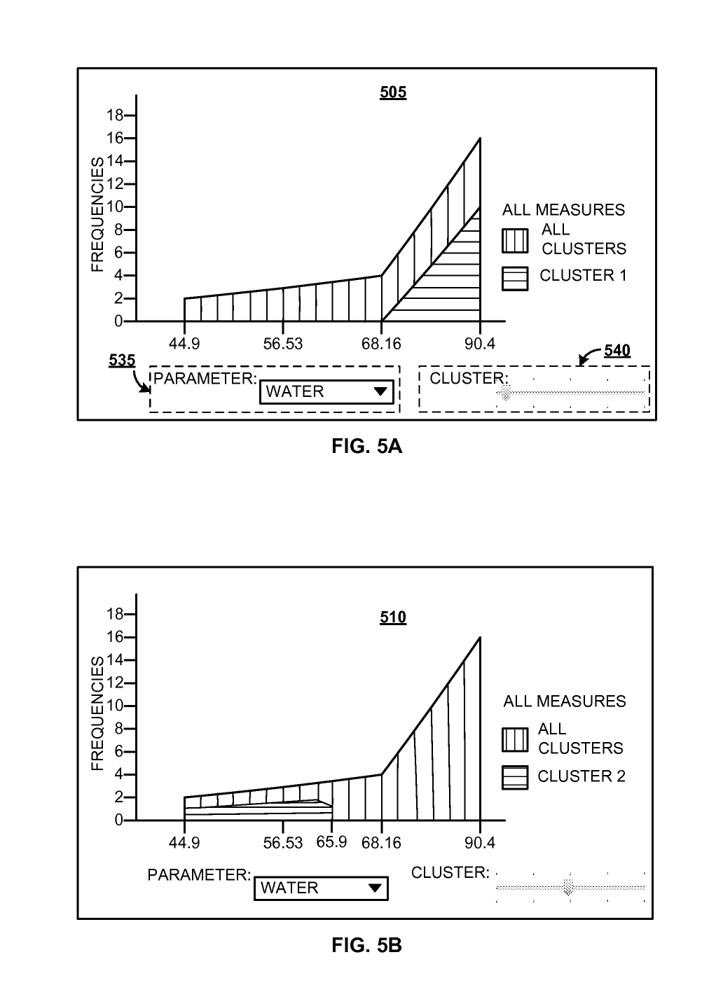

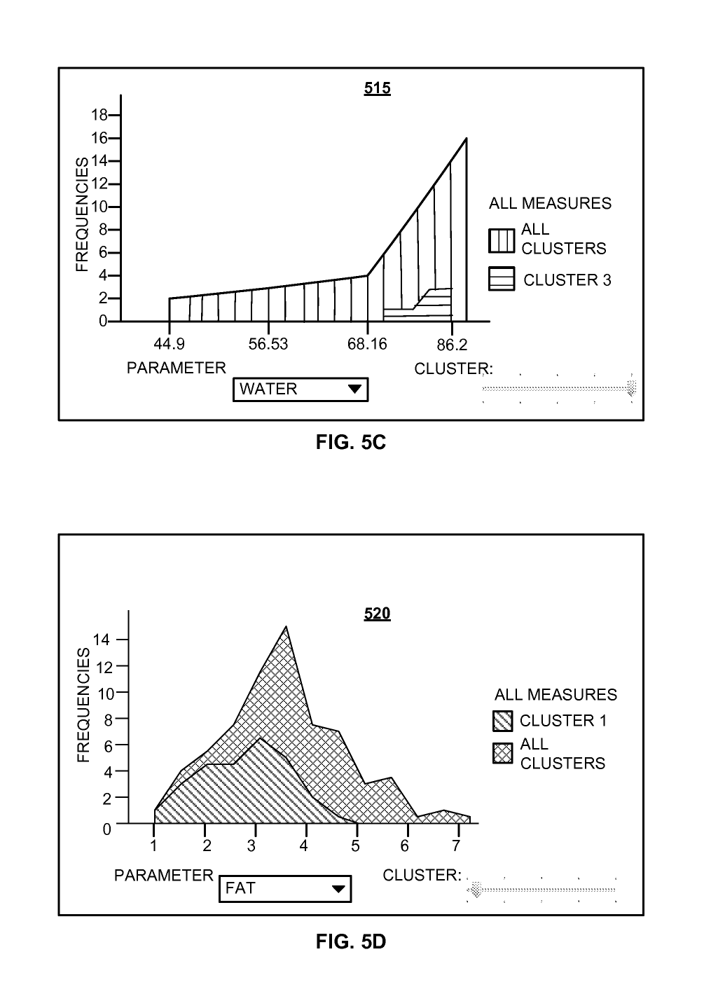

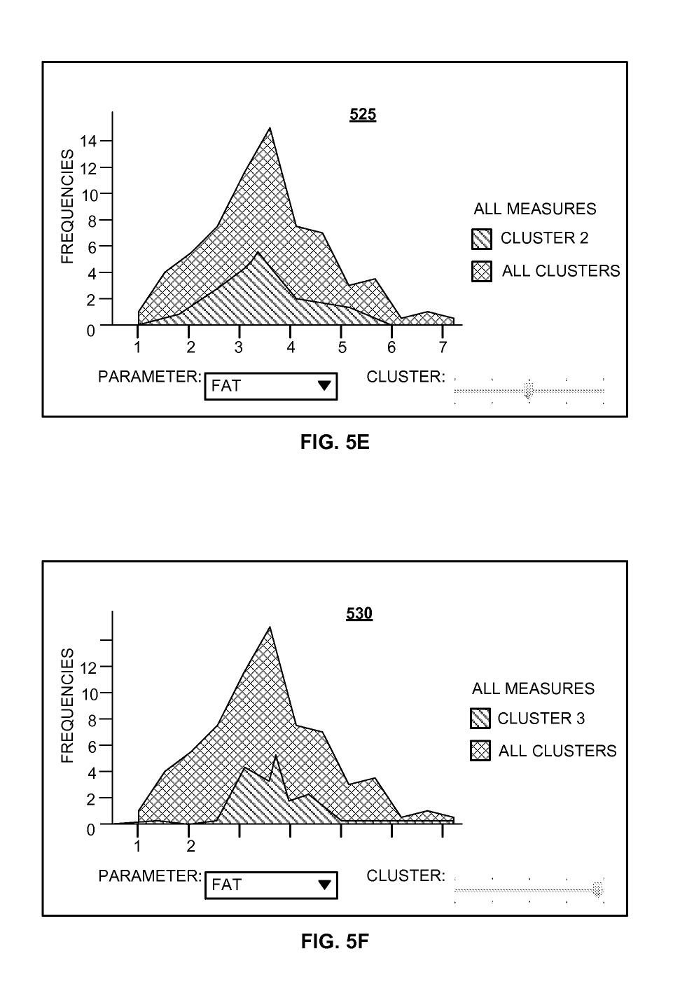

In one embodiment, a third portion 220 graphically displays parameters associated with the one or more data clusters, which is useful to compare the corresponding parameters of each data cluster. With regard to an example depicted in Table 3, the third portion 220 graphically displays the percentage of water in the data cluster 1 when compared to percentage of water in all the data clusters. The third portion 220 is described in greater detail in FIGS. 5A to 5F.

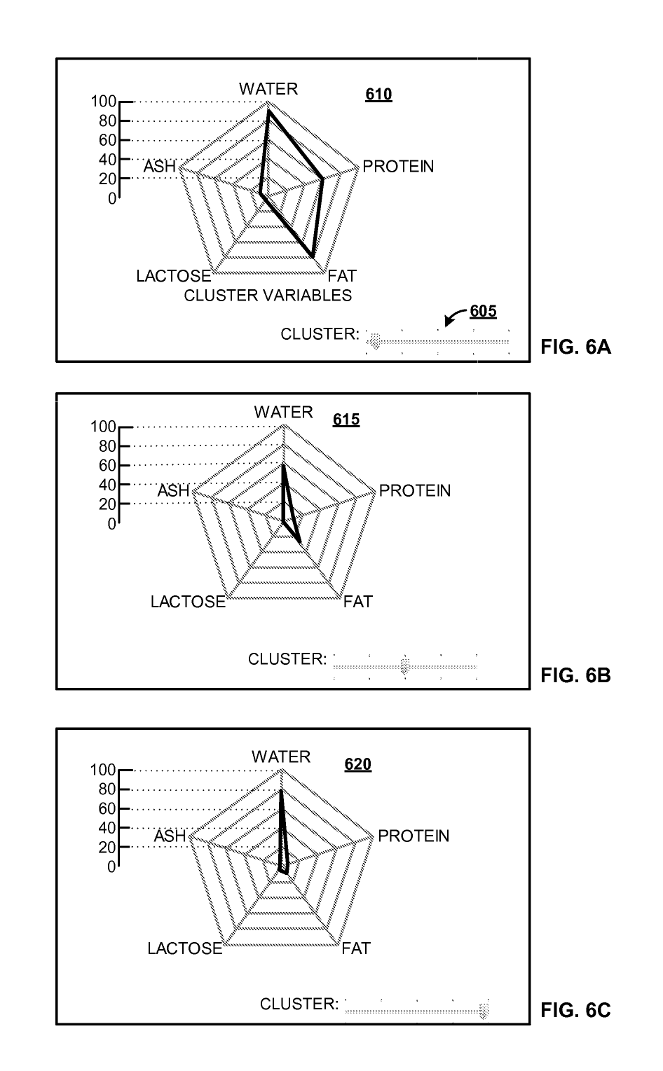

In one embodiment, a fourth portion 225 graphically displays a data chart to represent distribution of parameters in the data cluster. The center values of the parameters as depicted in Table 3 are graphically displayed in the fourth portion 225. The fourth portion 225 is described in greater detail in FIGS. 6A to 6C.

FIGS. 3A and 3B illustrate a first portion (e.g., 305A and 305B) of a visualization panel, according to an embodiment. The number of data records in the data clusters is graphically displayed in the first portion (e.g., 305A and 305B). For example, as depicted in Table 3, data cluster 1 includes 10 data records (e.g., 310), data cluster 2 includes 5 data records (e.g., 320) and data cluster 3 includes 10 data records (e.g., 315). The x-axis represents number of data records and the y-axis represents the cluster number. Further, the number of data records in each data cluster is graphically represented (e.g., 310, 315 and 320). Further, the total number of data records is graphically displayed (e.g., 325) in the first portion 305.

In one exemplary embodiment, a drop down menu 330 is provided to a user to select a type of a chart to present the number of data records in the data clusters. For example, the type of chart can be a bar chart, a cylinder chart, a cone chart, a pyramid chart, or a pie chart. The bar chart is selected to present the number of data records in the data clusters as shown in the first portion 305A of FIG. 3A. Similarly, the pie chart is selected to present the number of data records in the data clusters as shown in the first portion 305B of FIG. 3B.

FIG. 4 illustrates a second portion 400 of a visualization panel, according to an embodiment. The second portion 400 displays density of data clusters and the proximity between the data clusters. In one exemplary embodiment, the data clusters are presented in the form of a node (e.g., 405A to 405C). Node 405A represents data cluster 1, node 405B represents data cluster 2 and node 405C represents data cluster 3. Further, size of the nodes (e.g., 405A to 405C) depicts the number of data records of the data clusters. In one exemplary embodiment, the size of the nodes (e.g., 405A to 405C) is determined by the ratio as shown in Equation 1.

$$Sum of Data Clusters = Data Cluster 1 + Data Cluster 2 + … + Data Cluster N \\ Ratio \% of N data clusters = \frac{Data Cluster 1 * 100}{Sum of Data Clusters} \text{:} \frac{Data Cluster 2 * 100}{Sum of Data Clusters} \text{:} … \text{:} \frac{Data Cluster N * 100}{Sum of Data Clusters} \qquad ( 1 )$$

For the example illustrated in Table 1, the number of data records of the data clusters is depicted in Table 4:

TABLE 4

| Data Cluster No. | Number of data records |
|---|---|
| Data Cluster 1 | 10 |
| Data Cluster 2 | 5 |
| Data Cluster 3 | 10 |

Further, using Equation 1:

Ratio % of three data clusters=Data Cluster 1:Data Cluster 2:Data Cluster 3=40%:20%:40%

Thereby, the size of the nodes (e.g., 405A to 405C) is displayed accordingly in the second portion 400. Hence, the number of data records in the data clusters can be visualized and compared through the size of the nodes (e.g., 405A to 405C).

In one exemplary embodiment, the density of the data clusters are graphically displayed using shades or a color scale depicting density from lower value to higher value. The sum of squares as depicted in Table 3 is used to represent the density of the data clusters.

$$Total sum of squares of N clusters = sum of squares [ data cluster 1 ] + sum of squares [ data cluster 2 ] + … + sum of squares [ data cluster N ] \\ Sum of squares ratio \% of N data clusters = \frac{\begin{matrix}sum of squares \\ [ data cluster 1 ] * 100\end{matrix} }{Total sum of squares} \text{:} \frac{\begin{matrix}sum of squares \\ [ data cluster 2 ] * 100\end{matrix} }{Total sum of squares} \text{:} … \text{:} \frac{\begin{matrix}sum of squares \\ [ data cluster N ] * 100\end{matrix} }{Total sum of squares} \qquad ( 2 )$$

Using equation (2),

Sum of squares ratio % of three data clusters=4.2%:63.5%:32.14%

To represent the density of the data clusters graphically, the nodes of the data clusters are shaded darker to represent high density and vice versa. In other words, 0% being lighter shade having less density and 100% being higher shade having greater density. Therefore, the node 405A representing data cluster 1 has lighter shade when compared to the node 405B and the node 405C. Similarly, the node 405B has higher shade. Hence, the density of each data cluster may be compared with the other data clusters graphically on the visualization panel.

In one exemplary embodiment, a density index 410 is provided in the second portion 410 to graphically compare different data cluster's density. The density index 410 includes a color scale from low to high. Accordingly, the density of the data clusters is represented as shown in 410. Hence, graphical visualization of data cluster's density using the density index 410 will help to compare density of the data cluster more effectively.

In one embodiment, proximity between the data clusters is graphically represented on the second portion 400 of the visualization panel. For example, node connecting lines (e.g., 415, 420 and 425) are used to graphically represent the proximity between the data clusters.

In one exemplary embodiment, the thickness of the node connecting lines (e.g., 415, 420 and 425) illustrates the proximity between the nodes (e.g., 405A to 405C). The thickness of the node connecting lines (e.g., 415, 420 and 425) is determined by distance between the center values of the nodes (e.g., 405A to 405C) using standard Euclidean distance, defined as:

\sqrt{Σᵢ₌₁ⁿ(qᵢ−pᵢ)²}.

Consider p=(p₂, p₂, . . . , pₙ) and q=(q₁, q₂, . . . , qₙ), where p and q are co-ordinates of data cluster centers.

For i=1 to NumberOfDataClusters
For j=i+1 to NumberOfDataClusters
Total_Distance=Total_Distance+Euclidean_Distance(Data Cluster[i], Data Cluster[j])
End-For

End-For

Therefore, by executing the above steps, the distances between the nodes (e.g., 405A to 405C) are calculated. For example, the distance between the node 405A and the node 405B is calculated as 110.17. The distances between the node 405B and the node 405C as 29.34. Similarly, the distance between the node 405A and the node 405C as 128.71. The distances between the nodes (e.g., 405A to 405C) are graphically represented by the thickness of the node connecting lines (e.g., 415, 420 and 425). As shown in the second portion 400, the node connecting line 420 is leaner compared to the other two node connecting lines (e.g., 415 and 425) indicating that the parameters of the data cluster 1 and the data cluster 2 are not closer. Similarly, the node connecting line 425 is thicker leaner compared to the other two node connecting lines (e.g., 415 and 420) indicating that the parameters of the data cluster 2 and the data cluster 3 are closer. Therefore, thicker the node connecting lines (e.g., 415, 420 and 425), closer the data clusters. Thus, providing information regarding how close the data clusters are. Using such information, the data clusters are analyzed. When the data clusters are very close, the user may think of merging the data clusters (e.g., decreasing the value of ‘k’ in the ‘K-Means algorithm) or else add another data cluster to the existing data clusters (e.g., increasing the value of ‘k’ in the ‘K-Means algorithm).

FIGS. 5A to 5F illustrate a third portion 500 of a visualization panel, according to an embodiment. The third portion 500 presents distribution of parameters within each data cluster. The x-axis represents numerical value of a parameter and the y-axis represents the frequency of the parameter in a data cluster.

In one exemplary embodiment, a drop down menu 535 is provided for the user to choose desired parameter. For example, in 505 of FIG. 5A, 510 of FIGS. 5B and 515 of FIG. 5C, water percentage parameter is selected. Further, a slider 540 is provided for the user to choose the data cluster. For example, in 505 of FIG. 5A, data cluster 1 is selected. In 510 of FIG. 5B, data cluster 2 is selected. In 515 of FIG. 5C, data cluster 3 is selected. Therefore, the water percentage in each data cluster is compared with the total water percentage. For example, water percentage in data cluster 1 is compared with total water percentage (e.g., 505 of FIG. 5A). The water percentage in data cluster 2 is compared with total water percentage (e.g., 510 of FIG. 5B). The water percentage in data cluster 3 is compared with total water percentage (e.g., 515 of FIG. 5C).

Similarly, in 520 of FIG. 5D, 525 of FIGS. 5E and 530 of FIG. 5F, fat percentage parameter is selected. Further, parameter fat percentage is compared with total fat percentage with respect to data cluster 1 (e.g., 520 of FIG. 5D), data cluster 2 (e.g., 525 of FIG. 5E) and data cluster 3 (e.g., 530 of FIG. 5F). Hence, with graphical representation of the distribution of each parameter in each data cluster, the parameters used to classify the data clusters are compared easily.

FIGS. 6A to 6C illustrate a fourth portion 600 of a visualization panel, according to an embodiment. The centers of the parameters as depicted in Table 3 are graphically displayed in the fourth portion 600. In one exemplary embodiment, a slider 605 is provided to select the data cluster. For example, in 610 of FIG. 6A, data cluster 1 is selected. In 615 of FIG. 6B, data cluster 2 is selected. And, in 620 of FIG. 6C, data cluster 3 is selected. Further, a radar chart is used to display the distribution of parameters in each data cluster. For example, when data cluster 1 is selected in the slider 605, the centers of the parameters associated with the data cluster 1 (e.g., depicted in Table 3) are displayed as shown in 610 of FIG. 6A. In one exemplary embodiment, Centroid 625 of the radar chart is dynamically adjusted to display the center values of the parameters. Further, the center values of the parameters are represented on the axes of the radar chart starting from the centroid point 625. For example, lines joining the data point at 88.5% of water 630, 2.57% of protein 635, 2.8% of fat 640, 5.68% of lactose 645 and 0.485% of ash 650 shows distribution of parameters in the data cluster 1.

Similarly, the center values of the parameters associated with the data cluster 2 and the data cluster 3 are graphically displayed in 615 of FIGS. 6B and 620 of FIG. 6C. Hence, the distribution of parameters in each data cluster is graphically represented on the visualization panel. Thereby, using the centroid of each data cluster in the radar chart, the attribute of each parameter associated with the data cluster may be analyzed visually.

The data cluster visualization described above graphically represents various characteristics of data clusters on the visualization panel. The visualization panel graphically represents density of the data clusters, number of data records in the data clusters, proximity of data clusters and distribution of parameters in the data clusters. Since detailed information of the data clusters are graphically displayed on the single visualization panel, it is easier to analyze the data clusters and their characteristics and understand how the data records are grouped into data clusters. Even though the data cluster visualization is explained using ‘K-Means’ algorithm, the data cluster visualization can be applicable to other centroid based cluster techniques.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

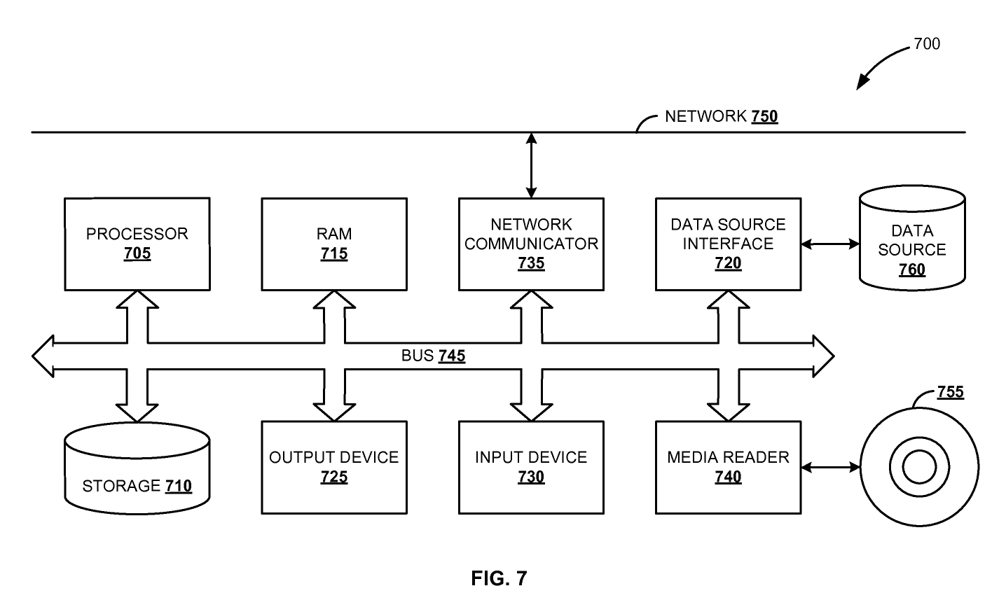

FIG. 7 is a block diagram of an exemplary computer system 700. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method to graphically display data clusters using a computer, the method comprising:
receiving a plurality of data records;
classifying the plurality of data records into one or more data clusters based on parameters associated with the plurality of data records; and
displaying a visualization panel on a computer generated graphical user interface to graphically indicate a number of data records in a data cluster of the one or more data clusters, a density of the data records in the data cluster and a proximity between the one or more data clusters.

2. The computer implemented method of claim 1, further comprising:
graphically displaying parameters associated with the one or more data clusters in the visualization panel; and
graphically displaying distribution of data in the data cluster of the one or more data clusters in the visualization panel.

3. The computer implemented method of claim 1, wherein classifying the plurality of data records comprises executing a data mining algorithm.

4. The computer implemented method of claim 1, wherein the density of the one or more data clusters is graphically represented using a numerical value of sum of squares, which is calculated based on the parameters using a data mining algorithm.

5. The computer implemented method of claim 2, wherein graphically displaying the parameters associated with the one or more data clusters comprises presenting a comparison of the parameters of the data cluster of the one or more data clusters.

6. The computer implemented method of claim 2, wherein the graphically displaying the distribution of data associated with the one or more data clusters comprises presenting a radar chart to represent distribution of data in the data cluster of the more or more data clusters.

7. A computer system to graphically display data clusters, the computer system including a display device and a processor programmed to display a graphical user interface (GUI) on the display device, the GUI comprising:
a first portion graphically displaying a number of data records in a data cluster of one or more data clusters;
a second portion graphically displaying density of the one or more data clusters and proximity between the one or more data clusters;
a third portion graphically displaying parameters associated with the one or more data clusters to compare the parameters of the data cluster; and
a fourth portion graphically displaying a data chart to represent distribution of data in the data cluster.

8. The computer system of claim 7, wherein the first portion comprises a drop down menu to select a type of a chart including a bar chart, a cylinder chart, a cone chart, a pyramid chart and a pie chart to present the number of data records in the one or more data clusters.

9. The computer system of claim 7, wherein the second portion comprises nodes to graphically present the one or more data clusters and node connecting lines to graphically present the proximity between the one or more data clusters.

10. The computer system of claim 9, wherein the number of data records in the one or more data clusters determines size of the nodes.

11. The computer system of claim 9, wherein the proximity between the one or more data cluster is indicated by thickness of the node connecting lines.

12. The computer system of claim 7, wherein the density of the one or more data clusters is graphically displayed using a density index having a color scale from low to high.

13. The computer system of claim 7, wherein the third portion comprises a slider to select the data cluster of the one or more data clusters and a drop down menu to select a parameter of the parameters associated with the one or more data clusters.

14. The computer system of claim 7, wherein the fourth portion comprises a slider to select the data cluster and a radar chart represent distribution of data in the selected data cluster of the one or more data clusters.

15. An article of manufacture including a tangible computer readable storage medium to physically store instructions, which when executed by a computer, cause the computer to:
receive a plurality of data records;
classify the plurality of data records into one or more data clusters based on parameters associated with the plurality of data records; and
present a visualization panel on a computer generated graphical user interface to graphically indicate a number of data records in a data cluster of the one or more data clusters, density of the data records in the data cluster and proximity between the one or more data clusters.

16. The article of manufacture of claim 15, further comprising instructions, which when executed by a computer, cause the computer to:
graphically present parameters associated with the one or more data clusters in the visualization panel; and
graphically present distribution of data in the data cluster of the one or more data clusters in the visualization panel.

17. The article of manufacture of claim 15, wherein classifying the plurality of data records comprises executing a data mining algorithm.

18. The article of manufacture of claim 15, wherein the density of the one or more data clusters is graphically represented using a numerical value of sum of squares, calculated based on the parameters using a data mining algorithm.

19. The article of manufacture of claim 16, wherein graphically presenting the parameters associated with the one or more data clusters comprises presenting a comparison of the parameters of the data cluster of the one or more data clusters.

20. The article of manufacture of claim 16, wherein the graphically displaying the distribution of data associated with the one or more data clusters comprises presenting a radar chart to represent distribution of data in the data cluster of the more or more data clusters.
